(19) United States
(12) Patent Application Publication
(10) Pub. No.: US 2017/0076211 A1
(43) Pub. Date: Mar. 16, 2017

(54) FEATURE-CONVERTING DEVICE, FEATURE-CONVERSION METHOD, LEARNING DEVICE, AND RECORDING MEDIUM

(71) Applicant: NEC Corporation, Minato-ku, Tokyo (JP)

(72) Inventors: Yukitaka KUSUMURA, Tokyo (JP); Ryohei FUJIMAKI, Tokyo (JP); Yasuhiro SOGAWA, Tokyo (JP); Satoshi MORINAGA, Tokyo (JP)

(73) Assignee: NEC Corporation, Minato-ku, Tokyo (JP)

(21) Appl. No.: 15/122,461

(22) PCT Filed: Mar. 3, 2015
(86) PCT No.: PCT/JP2015/001120

§ 371 Date: Aug. 30, 2016

Related U.S. Application Data
(60) Provisional application No. 61/971,585, filed on Mar. 28, 2014.

(51) Int. Cl. G06N 5/04; G06N 99/00

(52) U.S. Cl. CPC G06N 5/04; G06N 99/005

(57) ABSTRACT

A feature-converting device that provides good features quickly. The device includes first and second feature construction units and first and second feature selection units. The first feature construction unit receives one or more first features and constructs one or more second features that represent the results of applying a unary function to the respective first features. The first feature selection unit computes relevance between the first and second features and a target variable that includes elements associated with elements included in the first features and selects one or more third features that represent highly relevant features. The second feature construction unit constructs one or more fourth features that represent the results of applying a multi-operand function to the third features. The second feature selection unit computes the relevance between the third and fourth features and the target variable and selects at least one fifth feature that represents highly relevant features.

### TECHNICAL FIELD

The present invention relates to a feature-converting device and the like that convert features.

### BACKGROUND ART

A learning algorithm is a basic method in various devices, for example, as seen in an action determination device disclosed in PTL 1.

The action determination device disclosed in PTL 1 estimates an action of a user having a moving body by assigning an error-reduced state to a trajectory of the moving body. On the basis of information in which trajectory information regarding the trajectory is associated with action information regarding the action, the action determination device estimates a relationship between the trajectory information and the action information. In this case, the action determination device selects a specific feature from among features constituting the trajectory information and estimates (predicts) a relationship between the specific feature and the action information.

In other words, on the basis of learning information in which explanatory variables (for example, the above-mentioned trajectory information) are associated with a target variable (for example, the above-mentioned action information), a learning algorithm computes a relationship between the explanatory variables and the target variable. The learning algorithm applies the computed relationship to predictive information, thereby estimating a value of the target variable regarding the predictive information. When the learning algorithm estimates the value regarding the predictive information, explanatory variables representing the predictive information are the same as the explanatory variables in the learning information.

### CITATION LIST

### Patent Literature

PTL 1: Japanese Unexamined Patent Application Publication No. 2009-157770

### SUMMARY OF INVENTION

### Technical Problem

In general, in predictive analysis, a predictive model (a relationship between explanatory variables and a target variable) having high classification accuracy cannot be constructed only by explanatory variables prepared by an analyst.

It is effective to perform feature selection while performing feature construction for converting the given explanatory variables instead of using the prepared explanatory variables as it is in order to generate a predictive model having high classification accuracy.

However, generally, feature selection and feature construction are those involving an extremely large amount of computations. For example, when processing for taking logarithms of given features or arithmetic processing for combining a plurality of features are performed, an enormous number of features are constructed and thus all the features are needed to be evaluated.

For example, when the number of input features is assumed to be N. (2×N) features are constructed after each feature is processed by squaring and taking a logarithm. Additionally, features with an order of (3×N)³ are constructed after processing for choosing any three features from a feature set that includes the above constructed features and the original input features, and then multiplying the chosen three features.

Thus, it is a main object of the present invention to provide a feature-converting device and the like that can provide good features quickly.

### Solution to Problem

As an aspect of the present invention, a feature-converting device including:

first feature construction means for receiving one or more first features representing features including one or more elements composed of a numeral or a code, and constructing, by applying one or more unary functions that compute at least one of the features on the basis of at least one of the features to the received first features, one or more second features representing results of applying the unary operation functions to the first features;

first feature selection means for computing relevance between (i) the one or more second features and the one or more first features and (ii) a target variable that includes one or more elements composed of a numeral or a code associated with one or more of the elements included in the first features, and selecting one or more third features representing highly relevant features from among the one or more second features and the one or more first features;

second feature construction means for receiving the one or more third features and applying one or more kinds of multi-operand functions, which compute at least one of the features on the basis of one or more of the features, to the received third features, and constructing one or more fourth features representing the results of applying the multi-operand functions to the third features; and

second feature selection means for computing relevance between (iii) the one or more of the fourth features and the one or more third features and (iv) the target variable, and selecting at least one fifth feature that represents highly relevant feature from among the one or more of the fourth features and the one or more third features.

In addition, as another aspect of the present invention, a feature-converting method including causing an information processing device to includes:

receiving one or more first features representing features including one or more elements composed of a numeral or a code, and constructing, by applying one or more unary functions that compute at least one of the features on the basis of at least one of the features to the received first features, one or more second features representing results of applying the unary operation functions to the first features;

computing relevance between (i) the one or more second features and the one or more first features and (ii) a target variable that includes one or more elements composed of a numeral or a code associated with one or more of the elements included in the first features, and selecting one or more third features representing highly relevant features from among the one or more second features and the one or more first features;

receiving the one or more third features and applying one or more kinds of multi-operand functions, that compute at least one of the features on the basis of one or more of the features, to the received third features, and constructing one or more fourth features representing the results of applying the multi-operand functions to the third features; and

computing relevance between (iii) the one or more of the fourth features and the one or more third features and (iv) the target variable, and selecting at least one fifth feature that represents highly relevant feature from among the one or more of the fourth features and the one or more third features.

Furthermore, the object is also realized by a feature-converting program, and a computer-readable recording medium which records the program.

### Advantageous Effects of Invention

The feature-converting device and the like according to the present invention can provide good features quickly.

### BRIEF DESCRIPTION OF DRAWINGS

FIG. 1 is a block diagram depicting a structure of a feature-converting device according to a first exemplary embodiment of the present invention.

FIG. 2 is a flowchart depicting a processing flow in the feature-converting device according to the first exemplary embodiment.

FIG. 3 is a diagram conceptually representing one example of learning information.

FIG. 4 is a drawing conceptually representing one example of second features.

FIG. 5 is a drawing conceptually representing one example of values of a target variable.

FIG. 6 is a drawing representing one example of correlation coefficients between a target variable and first features and second features.

FIG. 7 is a drawing conceptually representing one example of fourth features.

FIG. 8 is a drawing representing one example of correlation coefficients between a target variable and fourth features.

FIG. 9 is a block diagram representing a structure of the feature-converting device according to the first exemplary embodiment.

FIG. 10 is a block diagram representing a structure of a learning device according to the first exemplary embodiment.

FIG. 11 is drawings each representing one example of values computed in a process of processing by a typical feature-converting device.

FIG. 12 is drawings each representing one example of values computed in a process of processing by a typical feature-converting device.

FIG. 13 is a block diagram depicting a structure of a feature-converting device according to a second exemplary embodiment of the present invention.

FIG. 14 is a block diagram depicting a structure of a feature-converting device according to a third exemplary embodiment of the present invention.

FIG. 15 is a block diagram schematically illustrating a hardware configuration of a calculation processing apparatus capable of realizing the feature-converting device according to each embodiment of the present invention.

### DESCRIPTION OF EMBODIMENTS

Now, terms and the like for helping understanding of the present invention will be described before describing exemplary embodiments for implementing the present invention.

In a learning algorithm, the more the explanatory variables are included in learning information, the more the computed relationship fits the learning information, while the less it fits predictive information representing information regarding a target to be predicted. The above-mentioned problem in the learning algorithm is known as overlearning problems. As a result of that, for example, when overlearning problems occur in the action determination device disclosed in PTL 1, accuracy of prediction declines.

According to an information criterion, appropriate setting of the amount of explanatory variables can alleviate overlearning problems in a learning algorithm. In learning algorithms, alleviating overlearning problems improves accuracy of prediction regarding predictive information.

For descriptive convenience, each feature is assumed to include a plurality of elements each including a numeral, a code, or the like.

Feature selections represent that an appropriate amount of features are selected from among features. Feature selections select an appropriate amount of features, for examples, on the basis of a score function for each feature. As for the score function, various methods are known, such as a correlation with respect to a target variable, an information gain, a chi-square value, and a Hilbert-Schmidt Independence Criterion.

In addition, feature constructions (feature conversions) are examples of methods for achieving high accuracy of prediction and convert a given feature to one or more appropriate feature.

Examples of feature constructions include a logarithmic function (log(x)), a square function (X×X), a binary function (to convert to the value of 0 or 1 on the basis of the value of X), a product function (Xᵢ×Xⱼ), and a quotient function (Xᵢ÷Xⱼ). Additionally, X represents one feature. Furthermore, Xᵢ and Xⱼ each represent one feature in a feature set representing a set of features, provided that 1≦i≦N and 1≦j≦N where N represents the number of features included in the feature set.

Additionally, in the present application, “log” means a logarithmic function. In addition, the base of the logarithmic function is, for example, a Napier's constant. However, the base of the logarithmic function is not limited to the Napier's constant.

Next, the technical problem to be solved by the present invention will be described in more detail. First, to facilitate understanding, the summary of related art of the present invention will be described.

The present applicant has filed U.S. Patent Application (provisional application) No. 61/883,660 (filed on Sep. 27, 2013) and International Patent Application No. PCT/JP2014/004520 that claims priority based on the US Patent Application, prior to filing of the present application. The invention disclosed in the patent application will be briefly described.

An information processing device disclosed in the patent application synthesizes a plurality of functions, thereby constructing a new function, and applies the constructed new function to a feature, thereby constructing a new feature. Next, the information processing device determines whether or not the constructed new feature satisfies a predetermined condition. For example, the information processing device synthesizes N (provided that N≧1) kinds of functions twice, thereby constructing (N×N) kinds of functions. Accordingly, when M (provided that M≧1) features are input, the information processing device constructs (M×N×N) features. In other words, since the information processing device can construct many features, the above-described overlearning problem can occur, depending on the situation, when learning processing is executed on the basis of the features.

Furthermore, the present applicant has filed U.S. Patent Application (provisional application) No. 61/883,672 (filed on Sep. 27, 2013) and International Patent Application No. PCT/JP2014/004706 that claims priority based on the US Patent Application, prior to filing of the present application. The invention disclosed in the patent application will be briefly described.

The information processing device disclosed in the patent application selects, for a function that takes a plurality of values as operands, a combination of features that serve as the operands from among a plurality of features and applies the function to the selected combination of the features, thereby constructing a new feature. Next, the information processing device determines whether or not the constructed new feature satisfies a predetermined condition. For example, the information processing device applies a function that takes two kinds of values as operands to M (provided that M≧1) kinds of features, thereby constructing (M×M) features. Accordingly, when there are N (provided that N≧1) kinds of functions that take two kinds of values as operands, the information processing device constructs (N×M×M) features. In other words, even the information processing device can construct many features, as in the application by the applicant of the present application. Thus, the above-described overlearning problem can occur depending on the situation in executing learning processing on the basis of the features.

Accordingly, feature selection needs to be executed for solving these overlearning problems. However, there is a problem in that as the number of features increases, a computation load for executing feature selection becomes larger.

Hereinafter, exemplary embodiments of the present invention capable of solving such problems will be described in detail with reference to the drawings.

### First Exemplary Embodiment

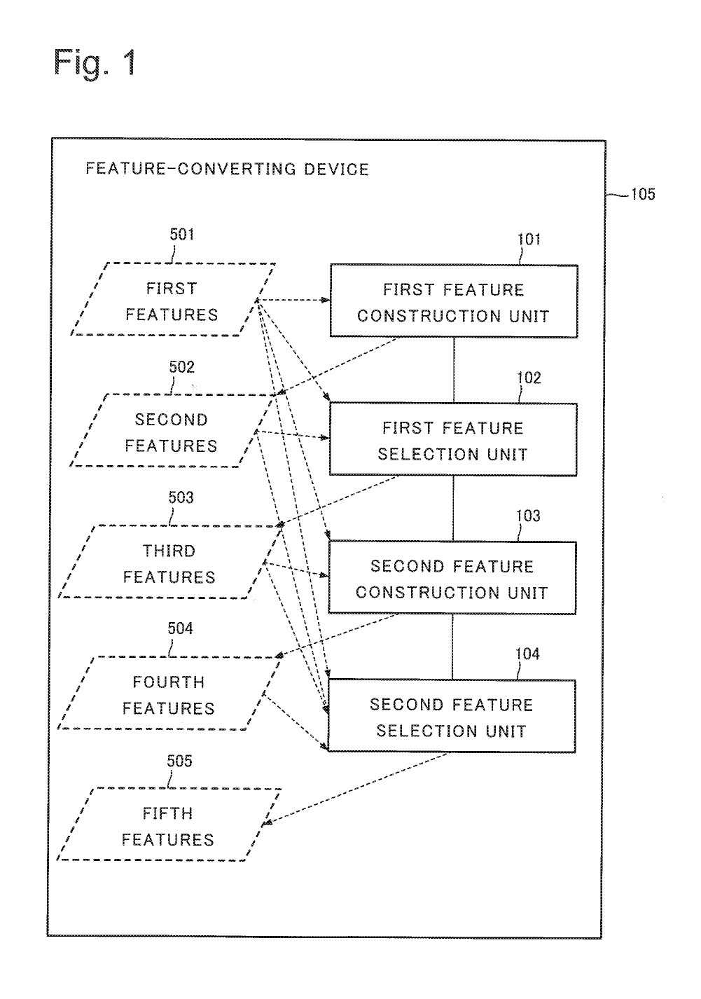

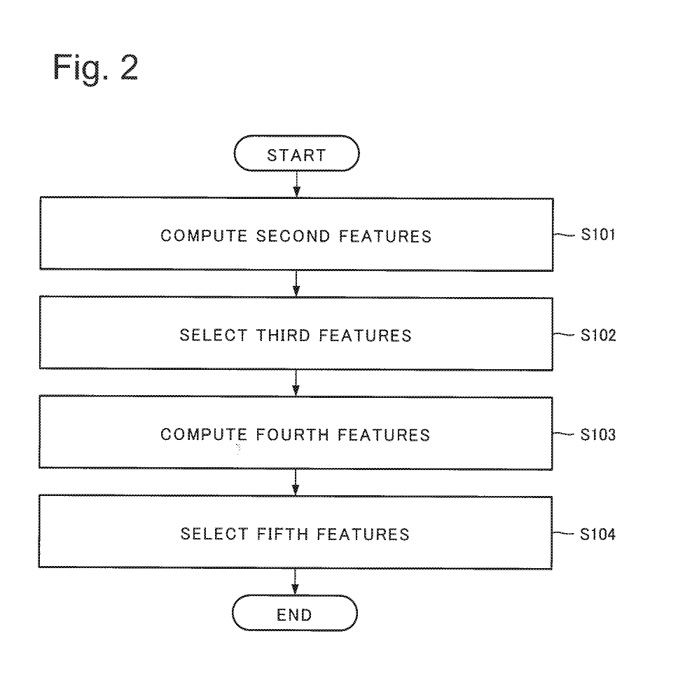

A structure of a feature-converting device 105 according to a first exemplary embodiment of the present invention and processing executed by the feature-converting device 105 will be described with reference to FIGS. 1 and 2. FIG. 1 is a block diagram depicting the structure of the feature-converting device 105 according to the first exemplary embodiment of the present invention. FIG. 2 is a flowchart depicting a processing flow in the feature-converting device 105 according to the first exemplary embodiment.

The feature-converting device 105 according to the first exemplary embodiment includes a first feature construction unit 101, a first feature selection unit 102, a second feature construction unit 103, and a second feature selection unit 104.

First, the first feature construction unit 101 applies arithmetic processing for computing one or more features on the basis of at least one or more features to the first features 501 in response to receipt of first features 501, thereby computing a second feature(s) 502 (step S101). For example, the arithmetic processing may be a unary function (single-operand function) for computing one feature on the basis of one feature. Examples of the unary function will be presented in a second exemplary embodiment that will be described later.

In addition, for descriptive convenience, the arithmetic processing to be applied in the first feature construction unit 101 is referred to as first arithmetic processing.

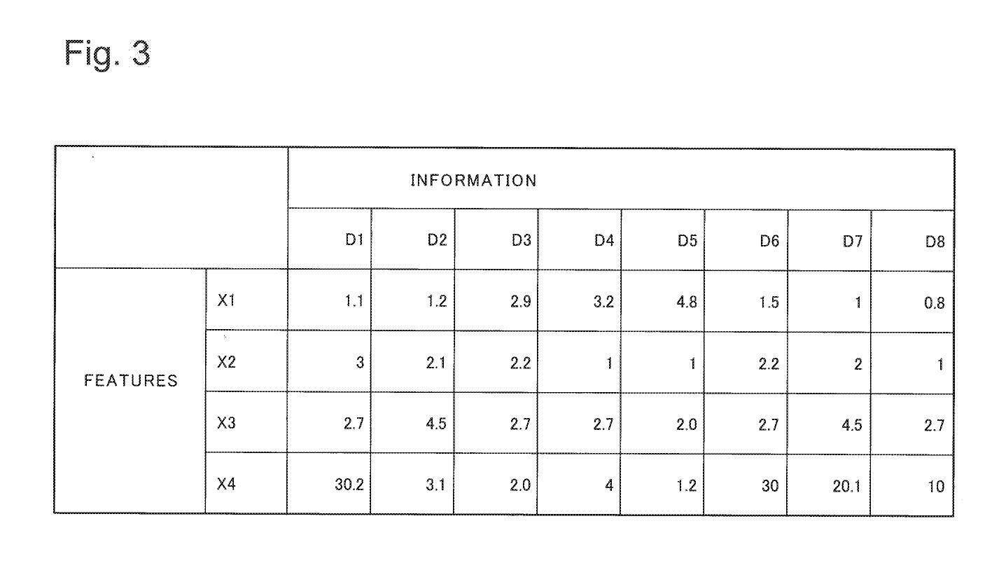

For example, the first features 501 are features (Xₙ, provided that n is an integer of from 1 to 4) included in learning information exemplified in FIG. 3. FIG. 3 is a diagram conceptually representing one example of learning information. Information received by the feature-converting device 105 may be the above-described predictive information. In other words, the first features 501 are, for example, features X1 to X4.

In the learning information exemplified in FIG. 3, the features (Xₙ) (provided that n represents a positive integer) are associated with information (Dₙ). Referring to FIG. 3, the learning information includes information D1 to D8. For example, the information D1 is represented using four numerical values (elements) 1.1, 3, 2.7, and 30.2. In addition, the information D2 is represented using four numerical values 1.2, 2.1, 4.5, and 3.1. In addition, the information D1 is represented as 1.1 and the information D3 is represented as 2.9 by using the feature X1. Similarly, the information D2 is represented as 4.5, and the information D5 is represented as 2.0 by using the feature X3.

In the example depicted in FIG. 3, regarding the information D1 to the information D8, the feature X1 represents, for example, a numerical value sequence of 1.1, 1.2, 2.9, 3.2, 4.8, 1.5, 1, and 0.8. In addition, the feature X2 represents a numerical value sequence of 3, 2.1, 2.2, 1, 1, 2.2, 2, and 1. In other words, in this example, the feature X1 includes the eight elements 1.1, 1.2, 2.9, 3.2, 4.8, 1.5, 1, and 0.8 regarding the information D1 to D8. Additionally, in this example, the feature X2 includes the eight elements 3, 2.1, 2.2, 1, 1, 2.2, 2, and 1 regarding the information D1 to D8.

In addition, with reference to FIG. 3, a description will be given using an example of predicting sales in a specific day on the basis of atmospheric temperatures. In this case, each of the pieces of the information D1 to D8 is information that represents a specific day (for example, a date). In this case, the information D1 is, for example, information that represents characteristics of a certain day. Additionally, the feature X1 represents, for example, an atmospheric temperature one month before the specific day, and the feature X2 represents an atmospheric temperature one week before the specific day. In this case, by referring to the atmospheric temperature one month before the specific day, a value that represents each specific day regarding the feature X1 can be determined. Similarly, for each specific day, by referring to the atmospheric temperature one week before the specific day, a value that represents the each specific day regarding the feature X2 can be determined. For example, the feature X3 and the feature X4 also, respectively, represent an atmospheric temperature three days before the specific day and an atmospheric temperature one day before the specific day, or the like.

In the above-described example, for example, when each of the pieces of the information D1 to D8 is associated with sales in a specific day, sales in a specific day can be predicted on the basis of atmospheric temperatures before the specific day.

In addition, although it has been assumed that the learning information includes the information D1 to D8, the learning information may include much more information. Additionally, although it has been assumed that each of the information D1 to D8 is represented using the features X1 to X4, the information D1 to D8 may be represented using many more features. In addition, in the example depicted in FIG. 3, the information D1 to D8 has been represented using numerical values according to the features X1 to X4, but may be codes, symbols, character strings, or the like.

For example, the first feature construction unit 101 applies a predetermined function such as sin(feature X1) or “feature 2”×log(feature X3) to the above-described features X1 to X4, thereby converting to new features (step S101). Additionally, the sin represents a sine that is a trigonometric function. For example, the predetermined function may be a function for converting N (provided that N is a positive integer) features to M (provided that M is an integer satisfying 1≦M≦N) different features, as in a method for selecting components having high contribution rate in principal component analysis. The predetermined function is not limited to the above-described example.

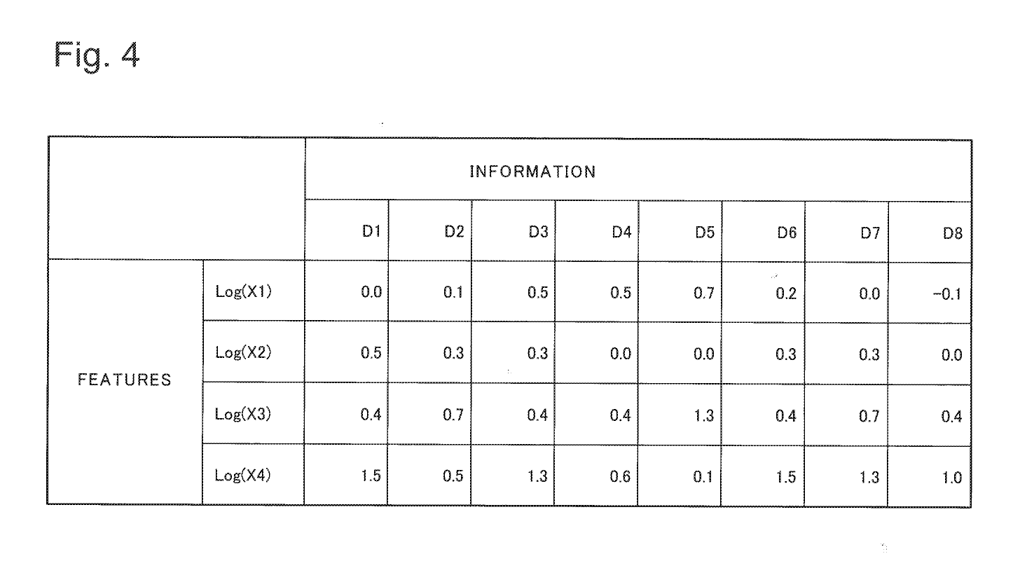

With reference to FIG. 4, a description will be given of the second features 502 that are computed by the first feature construction unit 101. FIG. 4 is a drawing conceptually representing one example of the second features 502. In the example depicted in FIG. 4, the first feature construction unit 101 applies a log function (provided that the log represents a logarithmic function) to the features X1 to X4, thereby computing the second features 502. In other words, regarding the feature X1, the first feature construction unit 101 computes a feature log(X1) as one of the second features 502. Similarly, regarding the feature X2, the first feature construction unit 101 computes a feature log(X2) as one of the second features 502. The same applies hereafter.

Next, the first feature selection unit 102 selects a third feature(s) 503 from the first features 501 and the second features 502 computed by the first feature construction unit 101 according to a feature selection procedure (step S102). Additionally, for descriptive convenience, the feature selection procedure in the first feature selection unit 102 is referred to as a first feature selection procedure.

When the feature selection procedure is, for example, a means that selects a feature(s) high in relevance (relativity) between features and a target variable, the first feature selection unit 102 selects a third feature(s) 503 by computing relevance between the features and the target variable.

The relevance can be computed, for example, on the basis of a Pearson's correlation coefficient, a cosine similarity, a Hilbert-Schmidt Independence Criterion (HSIC), or the like. Alternatively, the relevance can be computed on the basis of a Maximal Information Coefficient (MIC) or the like.

The feature selection procedure is not limited to the above-described example, and may be, for example, a method of selecting a specific feature(s) on the basis of a relevance among a plurality of (plural) features and a relevance between each feature and a target variable. Alternatively, the feature selection procedure may be a method of selecting a specific feature(s) on the basis of the relevance between the plurality of features. In this case, the feature selection procedure selects, for example, a feature(s) having a low relevance between the plurality of features. As the feature selection procedure, various methods are already known. Thus, the description thereof will be omitted.

Other than the above-described examples, various methods for relevance computation are already known. Thus, in the present exemplary embodiment, a detailed description regarding the method for relevance computation will be omitted.

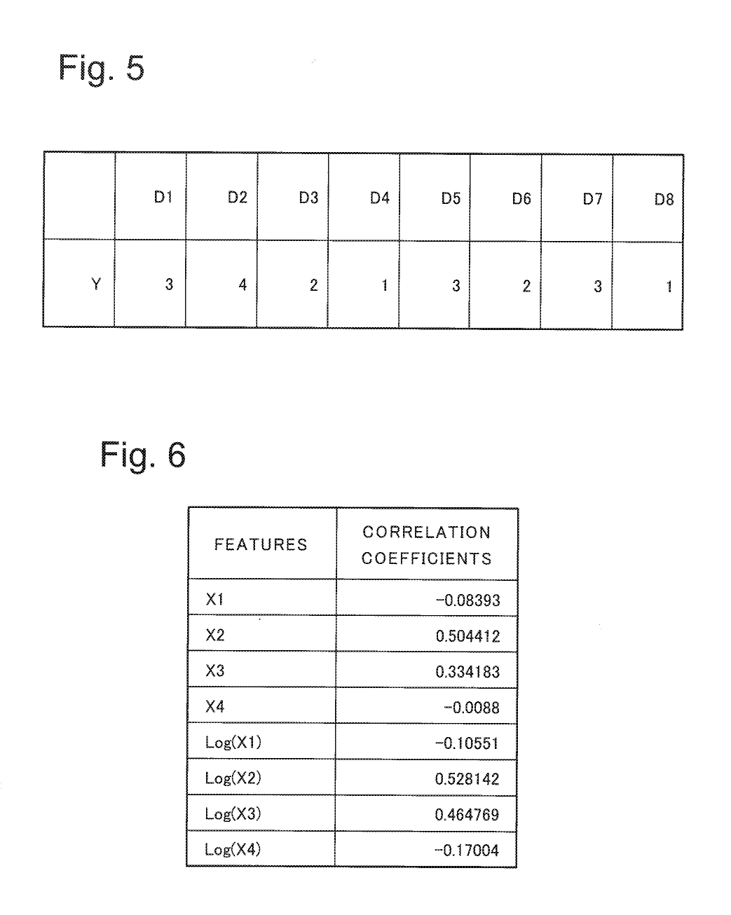

With reference to an example in which values of the target variable are those depicted in FIG. 5, a description will be given of processing by the first feature selection unit 102. FIG. 5 is a drawing conceptually representing one example of the values of the target variable.

Referring to FIG. 5, a target variable Y is associated with the information D1 to D8 described above. This indicates that a value of the target variable Y regarding the information D1 is 3, a value of the target variable Y regarding the information D2 is 4, and so on.

For example, the values of the target variable Y represent sales in specific days. In other words, in this example, the information D1 is information in which sales in a specific day are associated with an atmospheric temperature before the specific day. In addition, the information D2 is information in which a second specific day different from the specific day is associated with an atmospheric temperature before the second specific day. Learning information is, for example, information in which regarding the specific days represented by the information D1 to D8, the example depicted in FIG. 3 is associated with the example depicted in FIG. 5. In other words, the target variable includes a plurality of elements including numerals, codes, or the like associated with the individual elements included in the features.

For example, the first feature selection unit 102 computes correlation coefficients (FIG. 6) between the target variable Y and the features X1 to X4 and log(X1) to log(X4), thereby computing relevance between the features and the target variable. FIG. 6 is a drawing representing one example of the correlation coefficients between the target variable and the first and second features 501 and 502. For example, the correlation coefficient between the feature X1 and the target variable is −0.08393. In addition, the correlation coefficient between the feature log(X2) and the target variable is 0.528142. The larger the absolute value of the correlation coefficient is, the higher the correlation is. Conversely, the closer to 0 the absolute value of the correlation coefficient is, the lower the correlation is.

Next, the first feature selection unit 102 selects features highly relevant to the target variable Y. Referring to FIG. 6, the features X2, X3, log(X2), and log(X3) are features highly relevant to the target variable Y in the first features 501 and the second features 502. In this case, it may be determined whether the relevance is high or low by mutually comparing the relevance or by comparing the relevance with a specific value. In this case, the first feature selection unit 102 selects, for example, the features X2, X3, log(X2), and log(X3) as the third features 503.

In addition, the number of the third features 503 can be any number as long as it is smaller than a sum of the first features 501 and the second features 502. Thus, the number of the third features 503 is not limited to the above-described example.

In addition, in the above-described example, the feature selection has been assumed to be the means for selecting highly relevant features between features and a target variable. However, the feature selection may be a means in which indices representing relevance among features are further incorporated. In this case, the feature selection is a procedure for selecting features highly relevant to the target variable and lowly relevant to one another as the third feature(s) 503. Additionally, as the indices representing the relevance, indices such as correlation coefficients and information gain are already known. Thus, in the present exemplary embodiment, detailed descriptions of the indices and the feature selection will be omitted.

Next, the second feature construction unit 103 applies arithmetic processing that computes one or more features on the basis of at least one or more features to the third features 503 selected by the first feature selection unit 102 to compute fourth features 504 (step S103). For example, the second feature construction unit 103 applies a multi-operand function (polynomial function) that computes at least one feature on the basis of a plurality of features to the third features 503 to compute the fourth features 504. In addition, one example of the arithmetic processing is the polynomial function as shown in the second exemplary embodiment of the present invention.

For descriptive convenience, the arithmetic processing applied in the second feature construction unit 103 is referred to as second arithmetic processing.

In addition, the second feature construction unit 103 may compute the fourth features 504 on the basis of the first features 501 and the third features 503. In this case, since the first features 501 are features to be received, the second feature construction unit 103 computes the fourth features 504 on the basis of the features input by a user. When the features to be input by the user are previously known to be good features, the second feature construction unit 103 is highly likely to compute better features on the basis of the features.

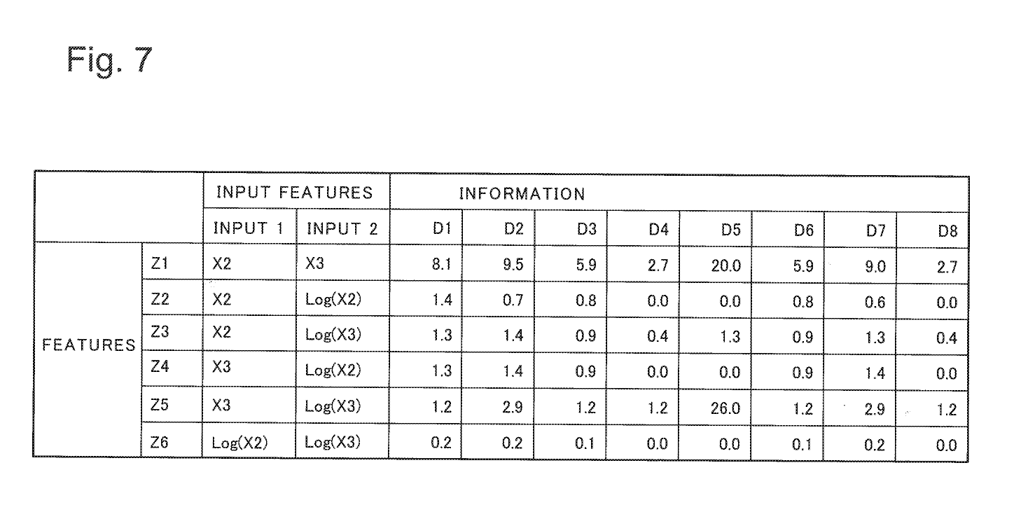

With reference to an example depicted in FIG. 7, a description will be given of processing regarding the second feature construction unit 103. FIG. 7 is a drawing conceptually representing one example of fourth features 504.

In the example depicted in FIG. 7, the second feature construction unit 103 computes the fourth features 504 by computing an element-by-element product regarding two third features 503. In this case, the fourth features 504 are features Z1 to Z6. For example, the second feature construction unit 103 computes the feature Z1 by computing an element-by-element product of the feature X2 and the feature X3. Similarly, the second feature construction unit 103 computes the feature Z4 by computing an element-by-element product of the feature X3 and the feature log(X2).

In addition, in the example depicted in FIG. 7, the fourth features 504 have been computed by computing the element-by-element product of the two third features 503. However, the features that serve as a base for computing the fourth features 504 do not necessarily have to be two features. The second feature construction unit 103 has computed the fourth features 504 by the products, but does not have to use products. The computation may be made using sums, differences, quotients, or the like, or may be made by a principal component analysis or the like. When the number of the features that serve as the base for computing the fourth features 504 is three or larger, the computation between the features does not have to be one kind of computation and may be a plurality of kinds of computations.

Next, the second feature selection unit 104 selects a fifth features 505 from the first features 501 to fourth features 504 according to a feature selection (step S104). Additionally, for descriptive convenience, the feature selection in the second feature selection unit 104 is referred to as second feature selection.

In addition, the feature selection in the second feature selection unit 104 may be the same as or different from the feature selection procedure in the first feature selection unit 102.

For example, when the feature selection is a means for selecting features highly relevant to a target variable, the second feature selection unit 104 selects a fifth features 505 by computing relevance between the features and the target variable.

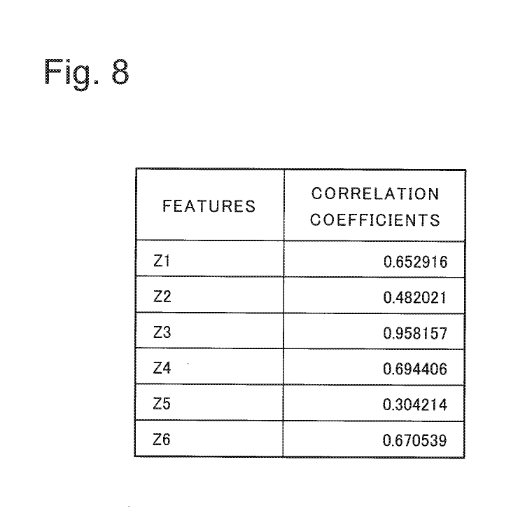

For example, the second feature selection unit 104 computes relevance by computing correlation coefficients between the target variable Y and the features Z1 to Z6 (FIG. 8). FIG. 8 is a drawing representing one example of correlation coefficients between a target variable and fourth features 504 (the features Z1 to Z6 in this example).

For example, referring to FIG. 8, the correlation coefficient between the feature Z1 and the target variable is 0.652916. Additionally, the correlation coefficient between the feature Z3 and the target variable is 0.958157. The larger the absolute value of the correlation coefficient is, the higher the relevance is. Conversely, the closer to 0 the absolute value of the correlation coefficient is, the lower the relevant is.

Next, the second feature selection unit 104 selects features highly relevant to the target variable Y. Referring to FIG. 8, the features Z3 and Z4 are features highly relevant to the target variable Y in the first features 501 to the fourth features 504. In this case, the second feature selection unit 104 selects the features Z3 and Z4 as the fifth features 505.

In addition, the number of the fifth features 505 can be any number as long as it is smaller than a sum of the first features 501 to the fourth features 504. Thus, the number of the fifth features 505 is not limited to the above-described example.

In addition, in the example described above, the feature selection has been assumed to be the means for selects features highly relevant to a target variable, but may be a means in which indices representing relevance among a plurality of features are additionally incorporated. In this case, the feature selection is a procedure for selecting feature(s) highly relevant to the target variable and lowly relevant to one another as the fifth features 505. Additionally, as the indices representing the relevance, indices such as correlation coefficients and information gain are already known. Thus, in the present exemplary embodiment, detailed descriptions of the indices and the feature selection will be omitted.

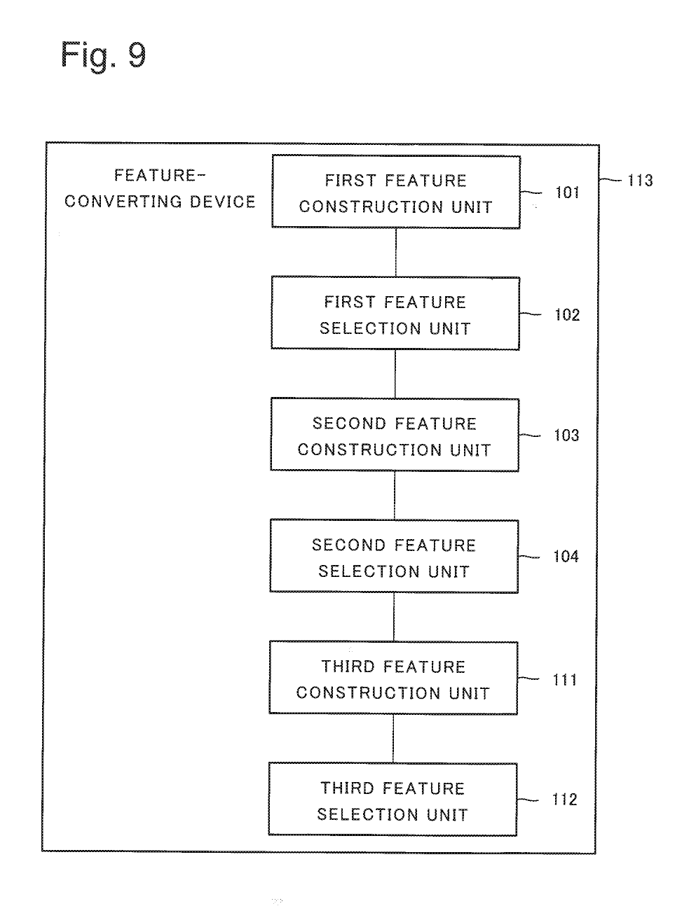

In addition, as depicted in FIG. 9, a feature-converting device 113 may further include a third feature construction unit 111 and a third feature selection unit 112. FIG. 9 is a block diagram representing a structure of the feature-converting device 113 according to the first exemplary embodiment. In this case, as with the first feature construction unit 101 and the second feature construction unit 103, the third feature construction unit 111 computes sixth features on the basis of the fifth features 505. Next, the third feature selection unit 112 selects a seventh features from among the first features 501 to the sixth features according to a feature selection method.

Furthermore, the feature-converting device 105 may include an aspect in which the feature construction unit constructs features and the feature selection unit selects on the basis of features such as the constructed features. In this case, the feature-converting device 105 repeatedly performs feature construction and feature selection.

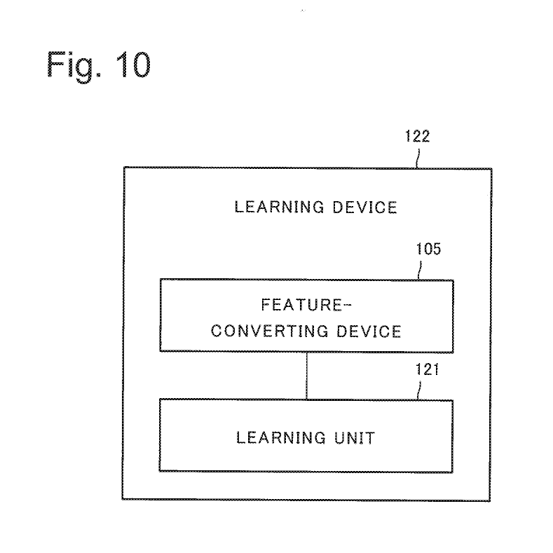

For example, the learning device 122 depicted in FIG. 10 may include a feature-converting device according to each exemplary embodiment of the present invention (for example, the feature-converting device 105). FIG. 10 is a block diagram representing a structure of the learning device 122 according to the first exemplary embodiment.

The learning device 122 includes the feature-converting device 105 and a learning unit 121.

The feature-converting device 105 constructs the fifth features 505 on the basis of the first features 501 according to the above-described procedure. Next, the learning unit 121 computes relationships between the explanatory variables and a target variable on the basis of learning information including the fifth features 505 as explanatory variables. Alternatively, the learning unit 121 applies the relationships to predictive information including the fifth features 505 as explanatory variables to estimate values regarding the predictive information.

Next, a description will be given of advantageous effects regarding the feature-converting device 105 according to the present exemplary embodiment.

The feature-converting device 105 according to the present exemplary embodiment can provide good features quickly. The reason for this is that the feature-converting device 105 reduces the number of arithmetic operations while maintaining the quality of features as compared to typical feature-converting devices.

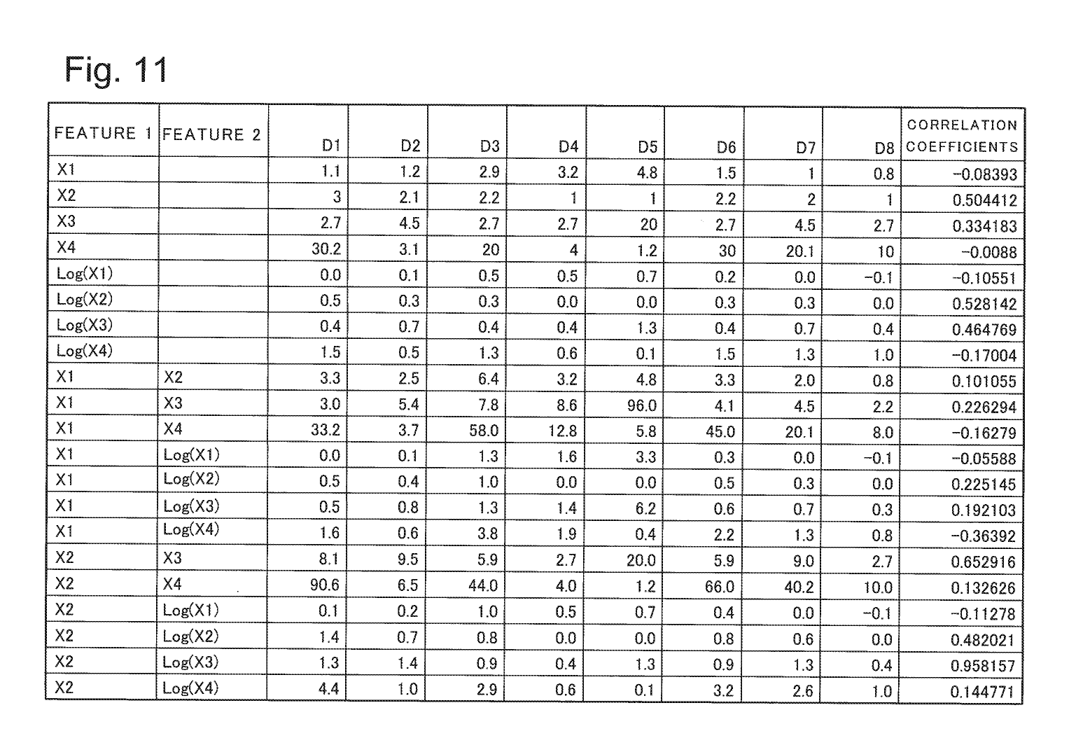

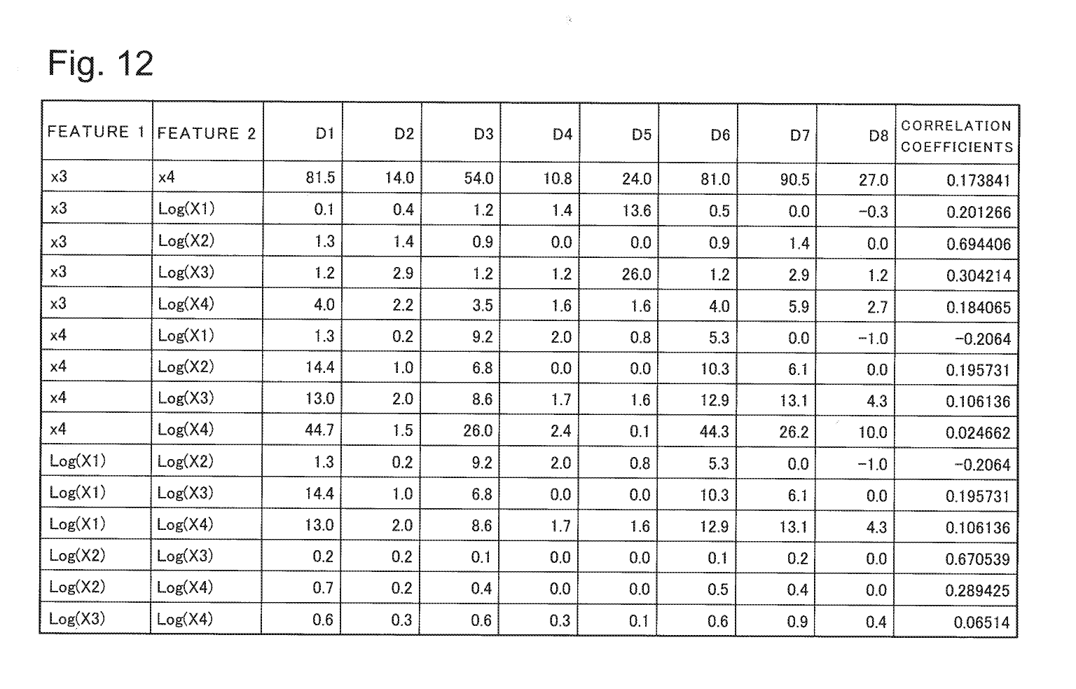

The reason will be described in detail with reference to FIGS. 11 and 12. FIGS. 11 and 12 are drawings each representing one example of values computed in a process of processing by a typical feature-converting device. In order to facilitate a comparison with the feature-converting device 105 according to the present exemplary embodiment, FIGS. 11 and 12 exemplify values computed by the typical feature-converting device in a case of receiving the features exemplified in FIG. 3.

As exemplified in PTL 1, the typical feature-converting device includes one feature construction unit and one feature selection unit. The feature construction unit computes new features on the basis of the received features. The feature selection unit selects some features from the new features.

For example, the typical feature-converting device applies a certain function to the received features to compute new features. In the examples depicted in FIGS. 11 and 12, the feature-converting device applies a logarithm (log) function to individual values constituting the received features to compute features in which the log has been applied. Next, the feature-converting device computes products of the received features and the features in which the log has been applied to compute new features (i.e., results of computations of per-element products regarding the features 1 and 2 in FIGS. 11 and 12).

Next, the feature selection unit of the typical feature-converting device computes relevance between the target variable (FIG. 5) and the new features. For example, when the relevance is represented as correlation coefficients, the feature selection unit computes values described in respective columns of a line indicating a function in FIGS. 11 and 12.

Specifically, in this example, in the typical feature-converting device, the feature selection unit receives as input 36 (=4 (received features)+4 (log-applied features)+8×7÷2 (features as products of each two features) features.

On the other hand, the feature-converting device 105 according to the present exemplary embodiment performs feature constructing processing and processing for selecting features from the constructed features and the like a plurality of times. The first feature selection unit 102 receives as input 8 (=4 (received features)+4 (log-applied features)) features. The second feature selection unit 104 receives as input 16 (=4 (received features)+4 (log-applied features)+6 (features computed by the second feature construction unit 103)) features.

As described above, in the typical feature selection means, the amount of computations sharply increases according to the number of input features. In this case, it is assumed that the typical feature selection means is a linear-order computational algorithm respect to the number of input features in case that the amount of computations by the typical feature selection means is estimated to be small. Even in this case, while the typical feature-converting device needs to process 36 features, the feature-converting device 105 according to the present exemplary embodiment processes 24 (=8+16) features. Accordingly, since the number of features to be processed is reduced, the feature-converting device 105 according to the present exemplary embodiment can provide features more quickly than the typical feature-converting device.

Next, it will be described that the feature-converting device 105 according to the present exemplary embodiment maintains the quality of features.

Referring to FIG. 8, a correlation coefficient that represents the highest correlation is 0.958157, which is a correlation coefficient between the feature Z3 computed by the feature-converting device 105 according to the present exemplary embodiment and the target variable. In addition, a correlation coefficient that represents the next highest correlation is 0.694406, which is a correlation coefficient between the feature Z4 computed by the feature-converting device 105 according to the present exemplary embodiment and the target variable. On the other hand, referring to FIGS. 11 and 12, a correlation coefficient that represents the highest correlation is 0.958157, and a correlation coefficient that represents the next highest correlation is 0.694406. Thus, for example, in evaluating the quality of features by using correlation coefficients as scales, it can be seen that the quality of features computed by the typical feature-converting device and the quality of features computed by the feature-converting device 105 according to the present exemplary embodiment are at the same level. Additionally, the same applies even in the use of relevance as described above (such as HSIC) as scales for evaluating the quality of features.

The feature-converting device 105 processes only a smaller number of features than the typical feature-converting device. Nevertheless, the comparison between features computed by the feature-converting device 105 and features computed by the typical feature-converting device indicates that the correlation coefficients between the features and the target variable are equal.

In addition, even when features highly relevant to the target variable are some features that constitute the features, they often have high relevance to the target variable. Conversely, in cases where there are low relevance between the some features and the target variable, even when features are constructed by combining the some features, relevance between the constructed features and the target variable are often low. The feature-converting device 105 according to the present exemplary embodiment constructs features highly relevant to a target variable in the step-by-step manner and therefore is unlikely to construct features lowly relevant to the target variable.

Furthermore, when the feature selection means is a relevance-based means, the higher the relevance of a feature with a target variable is, the better the quality of the feature is. Thus, the feature-converting device 105 according to the present exemplary embodiment can maintain the quality of features.

In addition, by repeating the feature constructing processing and the feature selecting processing in the feature-converting device 105, the number of features to be processed by the feature selection unit is further reduced. Thus, even in an aspect in which the feature-converting device 105 includes three or more feature construction units and three or more feature selection units, the feature-converting device 105 according to the present exemplary embodiment can provide good features more quickly.

A learning device that has the feature-converting device 105 according to the present exemplary embodiment estimates on the basis of good features provided by the feature-converting device 105. Accordingly, the learning device 122 according to the present exemplary embodiment can achieve high accuracy of prediction.

### Second Exemplary Embodiment

Next, a description will be given of the second exemplary embodiment of the present invention based on the above-described first exemplary embodiment.

In the following description, characteristic parts according to the present exemplary embodiment will be mainly described, and the same structural parts as those of the above-described first exemplary embodiment will be denoted by the same reference numerals, thereby omitting overlapping detailed descriptions thereof.

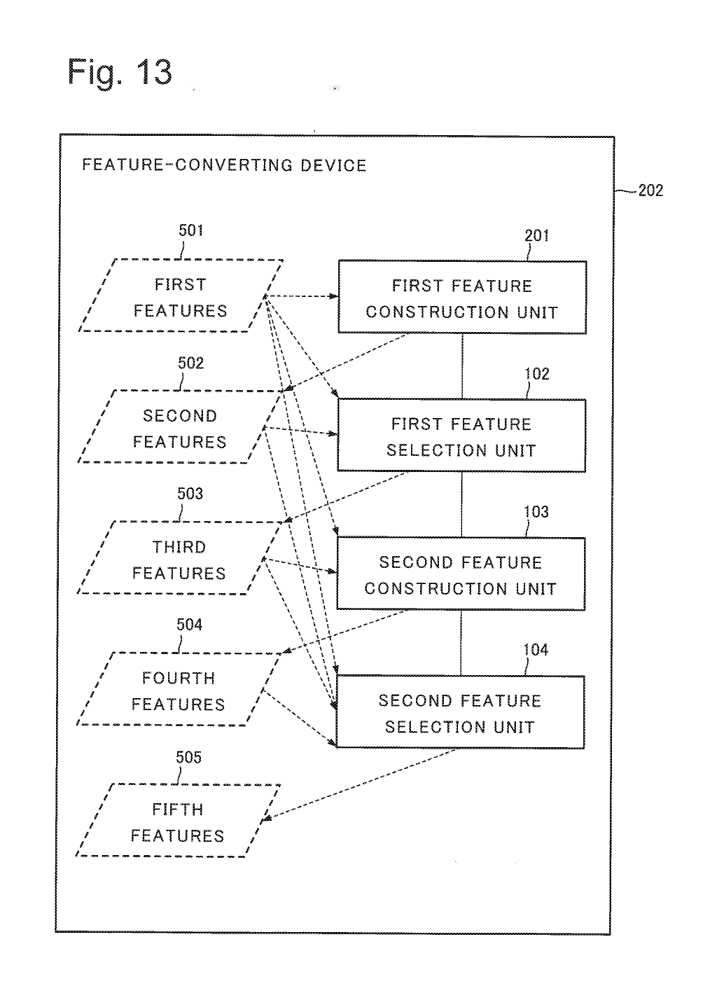

With reference to FIG. 13, a description will be given of a structure of a feature-converting device 202 according to the second exemplary embodiment and processing performed by the feature-converting device 202. FIG. 13 is a block diagram depicting the structure of the feature-converting device 202 according to the second exemplary embodiment of the present invention.

The feature-converting device 202 according to the second exemplary embodiment includes a first feature construction unit 201, the first feature selection unit 102, the second feature construction unit 103, and the second feature selection unit 104.

First, the first feature construction unit 201 applies a unary function, which computes one value on the basis of one value, to the elements of each of the first features 501, thereby computing the second features 502.

Examples of the unary function include various functions such as sin functions (sine functions), cos functions (cosine functions), exponential functions, logarithmic functions, polynomial functions, functions that provide frequencies in classification into a histogram, and deviations. Additionally, the unary function may be a function that rounds up or down values after the decimal point in a real number, or the like. In addition, the unary function may be a function that provides weather in an area to the name of the area, or the like. In addition, the one value may be, for example, a feature that represents a set of a plurality of values. When an input value is a feature, the unary function executes computation on the basis of the feature, and outputs a feature obtained as a result of the computation. For example, when the input value is a feature and the unary function is a logarithmic function, the unary function represents a function that applies the logarithmic function to each element of the feature to output computed values.

Such a unary function may be a function that computes 1 when the value of a certain one element of one or more elements constituting a feature is equal to or more than a specific threshold value, and computes 0 when the value of the one element is less than the specific threshold value.

In addition, the unary function may be a function that computes a moving average for each element included in a feature. In this case, for example, the unary function computes an average of one or more elements adjacent to an i-th element for the i-th element in the feature. The adjacent elements may be defined, for example, on the basis of a percentage (from about 1 to 10%) of the number of elements included in the feature.

In addition, the unary function may be a function that computes a value of a (i+k)-th element (or a (i−k)-th element) for an i-th element in the feature. k may be defined, for example, on the basis of the percentage (from about 1 to 10%) of the number of elements included in the feature.

The unary function is not limited to the above-described examples.

As the first arithmetic processing, the first feature construction unit 201 applies a unary function that computes one feature on the basis of one first feature 501 to each of the first features 501, thereby computing the second features 502.

Next, according to the feature selection procedure, the first feature selection unit 102 selects the third features 503 on the basis of the second features 502.

In addition, the second feature selection unit 104 may apply a polynomial function that computes one value on the basis of two or more values to each of the third features 503 to compute the fourth features 504.

Described will be advantageous effects regarding the feature-converting device 202 according to the present exemplary embodiment.

The feature-converting device 202 according to the present exemplary embodiment can provide better features more quickly than the feature-converting device 105 according to the first exemplary embodiment.

The reasons for this are twofold: reason 1 and reason 2. That is,

(Reason 1): The structural parts of the feature-converting device 202 according to the second exemplary embodiment include the structural parts of the feature-converting device 105 according to the first exemplary embodiment; and

(Reason 2): By reducing the number the features that are constructed by the first feature construction unit 201, processing by the first feature selection unit 102 is reduced as compared to that by the first feature selection unit 102 in the first exemplary embodiment.

Referring again to the examples depicted in FIGS. 11 and 12, the Reason 2 will be described in detail. As described above, each of FIGS. 11 and 12 is one example of features that are processed by a typical feature-converting device. The one example can be regarded as an example in which unary functions are an identity function and a log function, and a polynomial function that computes a product by computing one value on the basis of two values is applied to elements of the features in the second feature construction unit 103. In other words, the example can be considered as an example listing up all combinations that can be computed on the basis of the above-mentioned unary functions and polynomial function.

In addition, an input of the polynomial function may be features that represent a set of a plurality of elements. In this case, the polynomial function executes an arithmetic operation on the basis of the input features and outputs a feature obtained as a result of the operation. For example, when input values are two features and the polynomial function is multiplication, the polynomial function represents a function that outputs a value computed by multiplication between corresponding elements of the two features. Examples of the polynomial function can include logical OR operation, logical AND operation, logical exclusive OR operation, multiplication (product), and division (quotient).

Referring to FIGS. 11 and 12, it can be read that features having high correlation coefficients with the target variable are a feature X2×log(X3), a feature X3×log(X2), and a feature log(X2)×log(X3) among the features output by the typical feature-converting device. These features are those computed by combining the features X2, X3, log(X2), and log(X3).

Furthermore, the features X2, X3, log(X2), and log(X3) are found to respectively have higher correlation coefficients with the target variable than features X1, X4, log(X1), and log(X4).

On the other hand, the feature-converting device 202 can select the above-mentioned features having higher correlation coefficients (i.e., the third features) on the basis of the first features by applying the unary function to each of the first features 501 and, then, selecting the features on the basis of the results thereof. The feature-converting device 202 constructs fourth features on the basis of the third features and thus executes processing constructing features regarding the features that have high correlation coefficients and are in small numbers.

Accordingly, the feature-converting device 202 according to the present exemplary embodiment first applies a unary function and therefore can reduce processing for combining a plurality of features. Better features can be provided more quickly than in the feature-converting device 105 according to the first exemplary embodiment.

In addition, the second feature construction unit 103 performs processing for applying a polynomial function, whereby it can be prevented that the first feature construction unit 201 and the second feature construction unit 103 perform overlapping processing. As a result of this, the feature-converting device 202 according to the present exemplary embodiment can provide better features more quickly.

### Third Exemplary Embodiment

Next will be described a third exemplary embodiment of the present invention based on the above-described first exemplary embodiment.

In the following description, characteristic parts according to the present exemplary embodiment will be mainly described, and the same structural parts as those of the above-described first exemplary embodiment will be denoted by the same reference numerals, thereby omitting overlapping descriptions thereof.

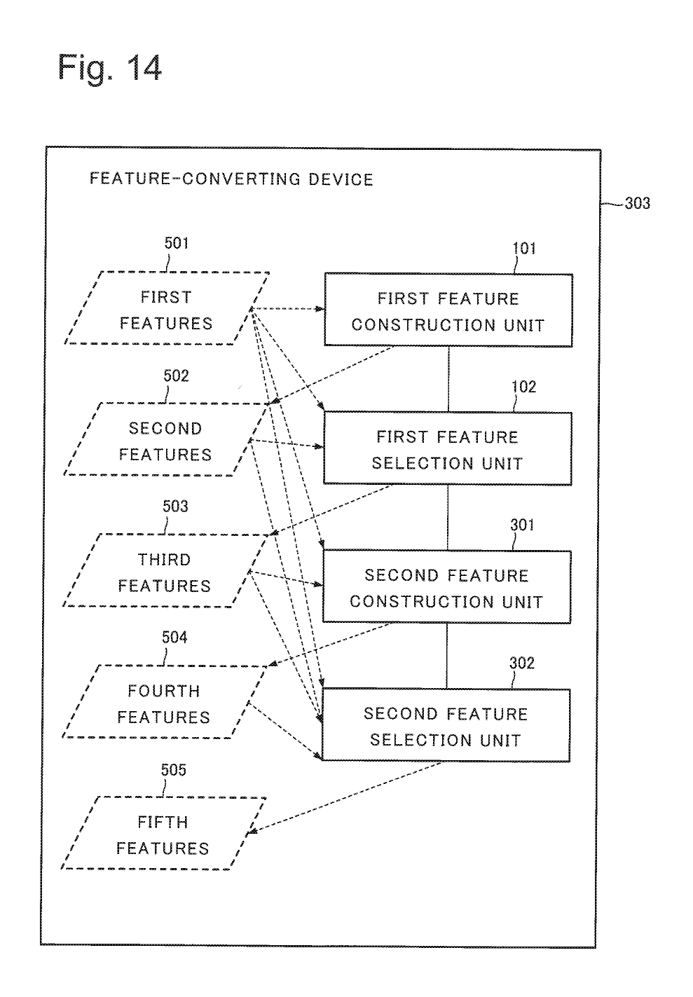

With reference to FIG. 14, a description will be given of a structure of a feature-converting device 303 according to the third exemplary embodiment and processing performed by the feature-converting device 303. FIG. 14 is a block diagram depicting the structure of the feature-converting device 303 according to the third exemplary embodiment of the present invention.

The feature-converting device 303 according to the third exemplary embodiment includes the first feature construction unit 101, the first feature selection unit 102, a second feature construction unit 301, and a second feature selection unit 302.

The second feature construction unit 301 applies a linear function to the third features 503 to construct the fourth features 504.

Next, the second feature selection unit 302 selects the fifth features 505 on the basis of the first features 501 to the fourth features 504 according to a feature selection procedure for selecting features according to indices based on the linear function.

For example, the linear function is an operation of a product, a sum, or the like.

Next will be described advantageous effects regarding the feature-converting device 303 according to the present exemplary embodiment.

The feature-converting device 303 according to the present exemplary embodiment can provide good features quickly, as well as can provide features easily understandable to a user.

The reasons for this are twofold: reason 1 and reason 2. That is,

(Reason 1) the structural parts of the feature-converting device 303 according to the third exemplary embodiment include the structural parts of the feature-converting device according to the first exemplary embodiment; and

(Reason 2) it can be prevented that a nonlinear function is additionally applied to features computed on the basis of a nonlinear function.

The reason 2 will be further described.

When the first feature construction unit 101 and the first feature selection unit 102 process on the basis of a nonlinear function, the third features 503 will be features computed by applying the nonlinear function to the first features 501. Accordingly, when the second feature construction unit 301 and the first feature selection unit 302 process on the basis of the nonlinear function, the fifth features 505 will be a features computed by applying the nonlinear function twice to the first features 501. In general, it is difficult for a user to understand values computed by applying a nonlinear function twice.

Accordingly, since the second feature construction unit 301 and the second feature selection unit 302 process on the basis of a linear function, it can be prevented that a nonlinear function is applied twice. As a result of this, the feature-converting device 303 according to the present exemplary embodiment can provide features easily understandable to a user.

Additionally, in the feature selection means, computation time is shorter in linear function-based processing than in nonlinear function-based processing. In other words, performing linear function-based processing by the second feature construction unit 301 and the second feature selection unit 302 reduces processing time in the second feature construction unit 301 and the second feature selection unit 302. Thus, the feature-converting device 303 according to the present exemplary embodiment can provide good features more quickly.

(Hardware Configuration Example)

A configuration example of hardware resources that realize a feature-converting device in the above-described exemplary embodiments of the present invention using a single calculation processing apparatus (an information processing apparatus or a computer) will be described. However, the feature-converting device may be realized using physically or functionally at least two calculation processing apparatuses. Further, the feature-converting device may be realized as a dedicated apparatus.

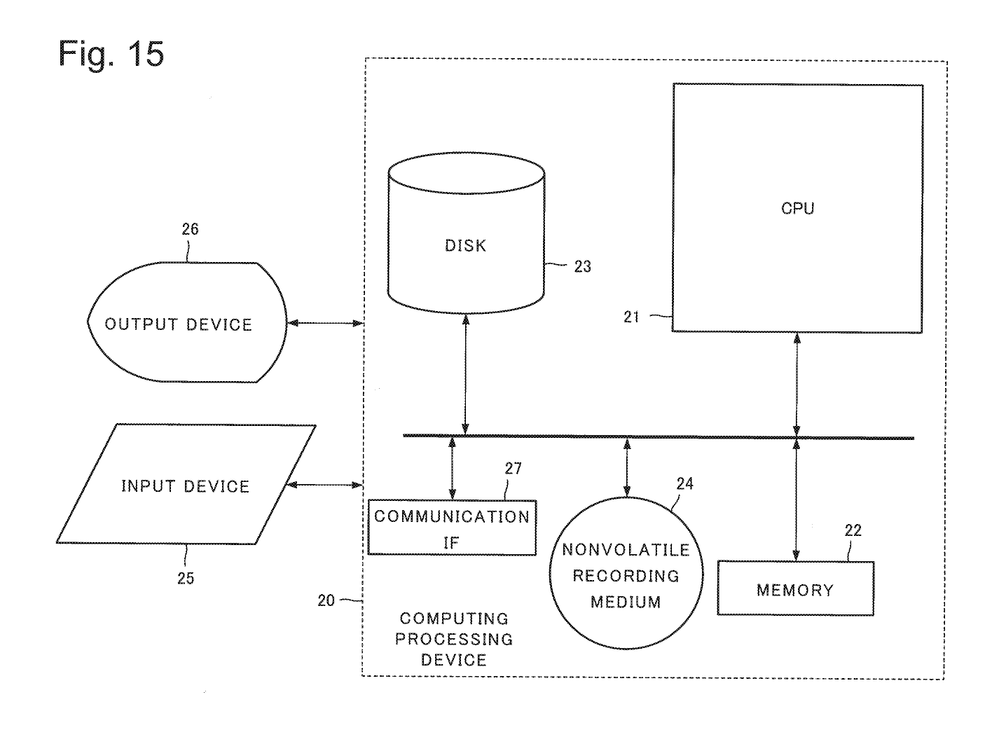

FIG. 15 is a block diagram schematically illustrating a hardware configuration of a calculation processing apparatus capable of realizing the feature-converting device according to each of the first exemplary embodiment to the third exemplary embodiment according to the sixth exemplary embodiment. A calculation processing apparatus 20 includes a CPU 21, a memory 22, a disc 23, a non-transitory recording medium 24, an input apparatus 25, an output apparatus 26, and a communication interface (hereinafter, expressed as a “communication I/F”) 27. The calculation processing apparatus 20 can execute transmission/reception of information to/from another calculation processing apparatus and a communication apparatus via the communication I/F 27.

The non-transitory recording medium 24 is, for example, a computer-readable Compact Disc, Digital Versatile Disc, Universal Serial Bus (USB) memory, or Solid State Drive. The non-transitory recording medium 24 allows a related program to be holdable and portable without power supply. The non-transitory recording medium 24 is not limited to the above-described media. Further, a related program can be carried via a communication network by way of the communication I/F 27 instead of the non-transitory medium 24.

In other words, the CPU 21 copies, on the memory 22, a software program (a computer program: hereinafter, referred to simply as a “program”) stored by the disc 23 when executing the program and executes arithmetic processing. The CPU 21 reads data necessary for program execution from the memory 22. When display is needed, the CPU 21 displays an output result on the output apparatus 26. When a program is input from the outside, the CPU 21 reads the program from the input apparatus 25. The CPU 21 interprets and executes a feature-converting program present on the memory 22 corresponding to a function (processing) indicated by each unit illustrated in FIG. 1, FIG. 9, FIG. 10, FIG. 13, or FIG. 14 described above or a feature-converting program (FIG. 2). The CPU 21 sequentially executes the processing described in each exemplary embodiment of the present invention.

In other words, in such a case, it is conceivable that the present invention can also be made using the feature-converting program. Further, it is conceivable that the present invention can also be made using a computer-readable, non-transitory recording medium storing the feature-converting program.

The present invention has been described using the above-described exemplary embodiments as exemplary cases. However, the present invention is not limited to the above-described exemplary embodiments. In other words, the present invention is applicable with various aspects that can be understood by those skilled in the art without departing from the scope of the present invention.

This application is based upon and claims the benefit of priority from U.S. patent application No. 61/971,585, filed on Mar. 28, 2014, the disclosure of which is incorporated herein in its entirety.

### REFERENCE SIGNS LIST

101 First feature construction unit
102 First feature selection unit
103 Second feature construction unit
104 Second feature selection unit
105 Feature-converting device
501 First features
502 Second features
503 Third features
504 Fourth features
505 Fifth features
111 Third feature construction unit
112 Third feature selection unit
113 Feature-converting device
121 Learning unit
122 Learning device
201 First feature construction unit
202 Feature-converting device
301 Second feature construction unit
302 Second feature selection unit
303 Feature-converting device
20 Computing processing device
21 CPU
22 Memory
23 Disk
24 Nonvolatile recording medium
25 Input device
26 Output device
27 Communication IF

What is claimed is:

1. A feature-converting device comprising:
a first feature construction unit configured to receive one or more first features representing features including one or more elements composed of a numeral or a code, and construct, by applying one or more unary functions that compute at least one of the features on the basis of at least one of the features to the received first features, one or more second features representing results of applying the unary operation functions to the first features;
a first feature selection unit configured to compute relevance between (i) the one or more second features and the one or more first features and (ii) a target variable that includes one or more elements composed of a numeral or a code associated with one or more of the elements included in the first features, and select one or more third features representing highly relevant features from among the one or more second features and the one or more first features;
a second feature construction unit configured to receive the one or more third features and applying one or more kinds of multi-operand functions, which compute at least one of the features on the basis of one or more of the features, to the received third features, and constructing one or more fourth features representing the results of applying the multi-operand functions to the third features; and
a second feature selection unit configured to compute relevance between (iii) the one or more of the fourth features and the one or more third features and (iv) the target variable, and select at least one fifth feature that represents highly relevant feature from among the one or more of the fourth features and the one or more third features.

2. The feature-converting device according to claim 1, wherein
the second feature construction unit applies, of the multi-operand functions, a multi-operand function that computes at least one of the features on the basis of two of the features to the third features.

3. The feature-converting device according to claim 2, wherein
the second feature construction unit applies, to the third features, second arithmetic processing that computes one of the features on the basis of one or more of the features and additionally can be applied to each of the elements constituting the features.

4. The feature-converting device according to claim 1, comprising:
third feature construction unit configured to compute one or more sixth features by applying a third arithmetic processing that computes one or more of the features on the basis of at least one or more of the features to the first features, the third features, or the fifth features; and
third feature selection unit configured to compute correlation of the one or more sixth features, the one or more of the fourth features, and the one or more second features with the target variable, and select at least one seventh feature that represents highly relevant features from among the one or more sixth features, the one or more of the fourth features and the one or more second features.

5. A learning device comprising:
the feature-converting device according to claim 1; and
learning unit configured to receive learning information in which one or more of the features are associated with the target variable, and execute learning operation or predictive operation on the basis of the features computed by the feature-converting device,
wherein the first feature construction unit receives the features included in the learning information as the first features.

6. A feature-conversion method comprising causing an information processing device to:
receiving one or more first features representing features including one or more elements composed of a numeral or a code, and constructing, by applying one or more unary functions that compute at least one of the features on the basis of at least one of the features to the received first features, one or more second features representing results of applying the unary operation functions to the first features;
computing relevance between (i) the one or more second features and the one or more first features and (ii) a target variable that includes one or more elements composed of a numeral or a code associated with one or more of the elements included in the first features, and selecting one or more third features representing highly relevant features from among the one or more second features and the one or more first features;
receiving the one or more third features and applying one or more kinds of multi-operand functions, that compute at least one of the features on the basis of one or more of the features, to the received third features, and constructing one or more fourth features representing the results of applying the multi-operand functions to the third features; and
computing relevance between (iii) the one or more of the fourth features and the one or more third features and (iv) the target variable, and selecting at least one fifth feature that represents highly relevant feature from among the one or more of the fourth features and the one or more third features.

7. A non-transitory recording medium storing a feature-conversion program that causes a computer to realize:
a first feature construction function configured to receive one or more first features representing features including one or more elements composed of a numeral or a code, and construct, by applying one or more unary functions that compute at least one of the features on the basis of at least one of the features to the received first features, one or more second features representing results of applying the unary operation functions to the first features;
a first feature selection function configured to compute relevance between (i) the one or more second features and the one or more first features and (ii) a target variable that includes one or more elements composed of a numeral or a code associated with one or more of the elements included in the first features, and select one or more third features representing highly relevant features from among the one or more second features and the one or more first features;
a second feature construction function configured to receive the one or more third features and applying one or more kinds of multi-operand functions, that compute at least one of the features on the basis of one or more of the features, to the received third features, and construct one or more fourth features representing the results of applying the multi-operand functions to the third features; and
a second feature selection function configured to compute relevance between (iii) the one or more of the fourth features and the one or more third features and (iv) the target variable, and select at least one fifth feature that represents highly relevant feature from among the one or more of the fourth features and the one or more third features.

8. The non-transitory recording medium storing the feature-conversion program according to claim 7, wherein
the second feature construction function applies, of the multi-operand functions, a multi-operand function that computes at least one of the features on the basis of two of the features to the third features.

9. The non-transitory recording medium storing the feature-conversion program according to claim 7, wherein
the second feature construction function applies, to the third features, second arithmetic processing that computes one of the features on the basis of one or more of the features and additionally can be applied to each of the elements constituting the features.

10. A non-transitory recording medium storing a learning program, the learning program causing a computer to realize
a learning function configured to receive for receiving learning information in which one or more of the features are associated with the target variable, and execute learning operation or predictive operation on the basis of the features computed according to the feature-conversion program according to claim 7, wherein;
the first feature construction function receives the features included in the learning information as the first features.
